(19) United States
(12) Patent Application Publication
(10) Pub. No.: US 2024/0300866 A1
(43) Pub. Date: Sep. 12, 2024

(54) OCHRE-CLAY-PHYLLOSILICATE ADDITIVE

(71) Applicant: Michael Mackenzie MINOGUE, Calumet, MI (US)

(72) Inventor: Michael Mackenzie MINOGUE, Calumet, MI (US)

(21) Appl. No.: 18/600,188

(22) Filed: Mar. 8, 2024

Related U.S. Application Data
(60) Provisional application No. 63/450,678, filed on Mar. 8, 2023.

(51) Int. Cl. C05F 3/00; C05F 11/06

(52) U.S. Cl. CPC C05F 3/00; C05F 11/06

(57) ABSTRACT

The disclosure relates to a method for producing a soil amendment composition through a process involving the addition of ochre, phyllosilicate, and clay to water in a reactor, followed by agitation to form a clay slurry, and concluding with a drying phase to achieve a specified moisture content. This composition may improve soil fertility, stabilize organic matter, and support environmental sustainability efforts.

### CROSS REFERENCE TO RELATED APPLICATION

This application claims the benefit of U.S. provisional application Ser. No. 63/450,678 filed Mar. 8, 2023, the disclosure of which is hereby incorporated in its entirety by reference herein.

### TECHNICAL FIELD

This disclosure pertains to compositions and methods for soil amendment and organic matter stabilization, specifically focusing on the utilization of ochre, phyllosilicates, and clay in agricultural and environmental management practices.

### BACKGROUND

The process of soil amendment and organic matter stabilization is crucial for enhancing soil fertility, sequestering carbon, and mitigating climate change impacts. The use of natural materials such as ochre, phyllosilicates, and clay in these processes has been known for centuries, albeit in rudimentary forms. Historically, ochre has been utilized as a pigment through distillation processes, however, these methods primarily distilled its color properties. These materials have the potential to improve the physical and chemical properties of soil, leading to better water retention, nutrient availability, and organic matter stabilization.

Despite the known benefits, the efficient and scalable application of these materials in modern agricultural and environmental management practices remains a challenge. The specific compositions and methods that maximize the benefits of these materials while minimizing adverse effects on indigenous microbial communities and the environment are not well-established. This is particularly relevant in the context of large-scale biomass processing operations, such as composting, biochar production, and sewage waste treatment, where the stabilization of organic matter is one objective.

Furthermore, the variability in soil types, climates, and agricultural practices across different regions necessitates a flexible and adaptable approach to soil amendment and organic matter stabilization. Traditional methods often lack the specificity and adaptability required to address these diverse conditions effectively. There is a need for compositions and methods that can be customized to the specific requirements of different environmental contexts, to facilitate soil improvement and carbon sequestration efforts.

### SUMMARY

In one aspect of the disclosure a method is presented. The method involves filling a reactor with water to a predetermined level. Then adding 1%to 50% by weight ochre, 1% to 50% by weight phyllosilicate, and 1% to 90% by weight clay to the water to form a mixture. Further agitating the mixture to form an aggregated clay slurry, and drying the aggregated clay slurry to form a soil amendment. The ochre used may be selected from a group comprising limonite, hematite, and goethite ores. The ochre used may have a maximum aggregate size of ⅜ inch. The phyllosilicate used may have a maximum aggregate size of ⅜ inch.

The agitation of the mixture may include further addition of water to form the aggregated clay slurry. The agitation step may also include pauses to allow for settling. The drying may be done until a moisture content of the clay is below 20%. The drying may be done by exposure to sunlight. The drying may be done by an external heat source.

In another aspect of the disclosure, a method for soil fortification is presented. Soil characteristics of a target application area are analyzed to determine specific soil deficiencies and environmental conditions. A composition of a soil amendment is calculated by adjusting percentages of ochre, phyllosilicate, and clay within ranges of 1% to 50%, 1% to 50%, and 1% to 90% by weight, respectively, based on the analyzed soil characteristics. A reactor is filled with water to a predetermined level and the calculated percentages of ochre, phyllosilicate, and clay are added to the water to form a mixture. The mixture is then agitated in the reactor until the ochre, phyllosilicate, and clay are thoroughly mixed to form a clay slurry. The clay slurry is then dried to achieve a moisture content below 20% to form a soil amendment. The soil amendment is then applied to the target application area.

The analysis of the soil characteristics may include testing for pH level, nutrient content, and moisture retention capacity. The calculation of the soil amendment composition may further consider seasonal variations in environmental conditions of the target application area. The agitation may be done by a mechanical agitator. The dying may be done using an electronic heat. The method may further involve testing the soil amendment composition prior to applying to the target application area.

In another aspect of the disclosure, a method for producing fertilizer is presented. To form the fertilize fill a reactor with water to a predetermined level and add 1% to 50% by weight ochre, 1% to 50% by weight phyllosilicate, and 1% to 90% by weight clay to the water to form a mixture. The mixture is agitated to form an aggregated clay slurry, which is then dried, then mixed with a biomass to form a fertilizer.

The biomass may include organic waste materials selected from the group comprising agricultural residue, food waste, yard trimmings, and animal manure. The mixing step may include adjusting the ratio of aggregated clay slurry to biomass based on the nutrient requirements of the intended application area. Drying the aggregated clay slurry may be done to achieve a final moisture content that optimizes the microbial activity beneficial for composting the biomass. The aggregated clay slurry may include specific ratios of ochre, phyllosilicate, and clay to promote specific beneficial properties in the fertilizer, such as pH adjustment, moisture retention, or nutrient release rates.

### BRIEF DESCRIPTION OF THE DRAWINGS

FIG. 1 is a flowchart of a method according to one embodiment;

FIG. 2 is a flowchart of a method according to one embodiment; and

FIG. 3 is a flowchart of a method according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure relates to compositions and methods for soil amendment and organic matter stabilization, focusing on enhancing agricultural productivity and environmental sustainability. The disclosed methods utilize a blend of ochre, phyllosilicates, and clay, aiming to improve soil properties, sequester carbon, and mitigate climate change impacts effectively.

In aspects of this disclosure, the integration of specific ratios of ochre, phyllosilicates, and clay is explored to create a versatile composition that can be tailored to different environmental and soil conditions. This allows for the optimization of soil amendment processes, catering to the unique needs of varied agricultural landscapes and enhancing the effectiveness of organic matter stabilization.

In one aspect of the disclosure, the application of this composition in large-scale biomass processing operations such as composting, biochar production, and sewage waste treatment is detailed. The innovative approach leverages the natural properties of the included materials to enrich the stability of organic aggregates, soil fertility, and contribute to efficient carbon sequestration. The methodological advancements allow for the flexible adaptation of the composition to suit specific operational needs and environmental conditions, maximizing the benefits of soil amendment and organic matter stabilization. A primary benefit of the ochre-clay mixture is the improvement of carbon sequestration efficiency.

In another aspect of the disclosure, the method for preparing the clay slurry composition is disclosed, emphasizing the significance of aggregate size, the order of ingredient addition, and the drying process in achieving optimal results. This detailed approach allows for the final composition to be effective for its intended purpose, providing a practical solution to the challenges faced in modern agricultural and environmental management practices. The composition's ability to increase carbon permanence in organic fertilizers from years to decades or centuries addresses a significant market need.

In yet another aspect, this disclosure further investigates the application of the clay slurry composition in enhancing the physical and chemical properties of soil, including water retention, nutrient availability, and microbial activity. By improving these soil characteristics, the disclosed composition and methods contribute to the creation of more fertile, resilient, and productive agricultural systems. Additionally, the environmental benefits of this approach, such as reduced emissions and enhanced carbon sequestration, align with global efforts to combat climate change, offering a sustainable and scalable solution to one of the most pressing challenges of our time. The adaptability and effectiveness of the disclosed compositions and methods underscore their potential to be readily utilized in soil amendment and organic matter stabilization practices, paving the way for more sustainable agricultural and environmental management strategies. The disclosed composition offers an improved carbon permanence in treated soils and fertilizers.

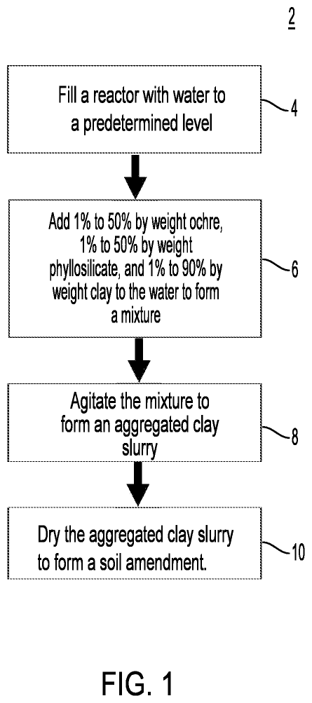

FIG. 1 shows a soil amendment method 2 beginning with step 4, where a reactor is filled to a predetermined level with water. This predetermined level is defined by optimal mixing and reaction conditions determined from experimental data and calculations. Various quantities of ochre, phyllosilicate, and clay, ranging from 1% to 50%, 1% to 50%, and 1% to 90% by weight respectively, are added to the reactor 6, to form a mixture. The ochre may comprise minerals such as limonite, hematite, or goethite, and both ochre and phyllosilicate components are limited to a maximum aggregate size of ⅜ inch. The mixture is then agitated 8, optionally including the addition of water and pausing to allow settling. The drying of the slurry 10, to a moisture content below 20%, can be achieved through exposure to sunlight or an external heat source.

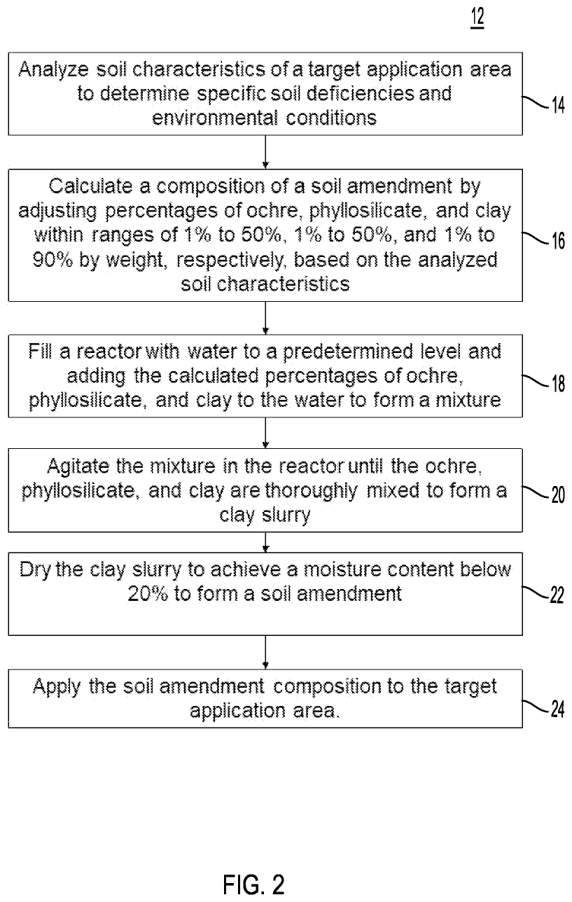

FIG. 2 shows a method for soil fortification 12, which involves analyzing soil characteristics 14, including pH, nutrient content, and moisture retention capacity. A soil amendment composition is calculated 16 and adjusted based on these characteristics and potential seasonal variations. This calculated blend is added to a reactor filled with water 18, creating a mixture that is agitated using a mechanical agitator to ensure homogeneity 20. The resultant clay slurry is dried 22 utilizing an electronic heat source to control the drying rate, ensuring uniform moisture content. Prior to application in the target area 24, the composition is tested for its amendment efficacy.

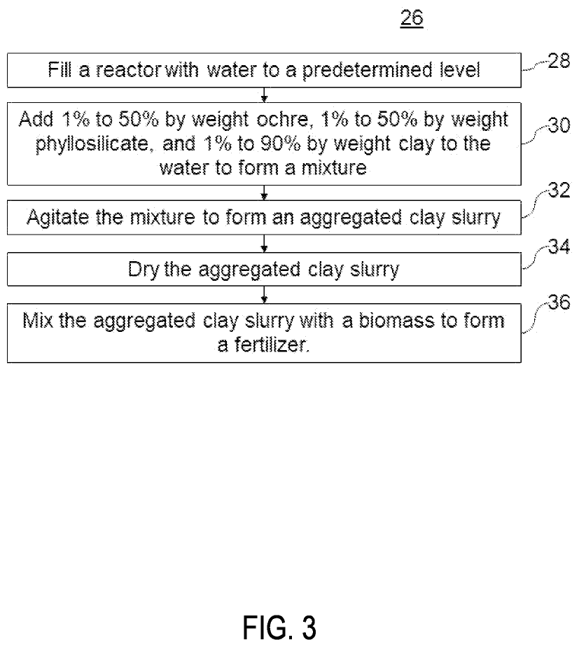

FIG. 3 shows a method for producing fertilizer 26, starting with filling a reactor with water 28 and adding a predetermined ratio of ochre, phyllosilicate, and clay 30. These ratios are calculated to meet the nutrient requirements of the intended application area. The mixture is agitated to form an aggregated clay slurry 32, which is then dried 34. This drying step is optimized to enhance microbial activity beneficial for composting. This dried slurry is mixed with a biomass 36 that may include agricultural residues, food waste, yard trimmings, or animal manure. Adjustments to the slurry-to-biomass ratio are made according to the nutrient requirements of the intended application area. Drying may be done to optimize microbial activity for composting, with the final slurry promoting beneficial properties in the fertilizer, such as pH adjustment, moisture retention, and controlled nutrient release.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method comprising:
filling a reactor with water to a predetermined level;
adding 1% to 50% by weight ochre, 1% to 50% by weight phyllosilicate, and 1% to 90% by weight clay to the reactor to form a mixture;
agitating the mixture to form an aggregated clay slurry; and
drying the aggregated clay slurry to form a soil amendment.

2. The method of claim 1 wherein the ochre is selected from a group comprising limonite, hematite, and goethite ores.

3. The method of claim 1 wherein the ochre has a maximum aggregate size of ⅜ inch.

4. The method of claim 1 wherein the phyllosilicate has a maximum aggregate size of ⅜ inch.

5. The method of claim 1 wherein the soil amendment is with a biomass to form a fertilizer.

6. The method of claim 1 wherein agitating the mixture includes pausing to allow for settling.

7. The method of claim 1 wherein the drying is continued until a moisture content of the clay is below 20%.

8. The method of claim 1 wherein the drying is via exposure to sunlight.

9. The method of claim 1 wherein the drying is via an electronic heat source.

10. A method for soil fortification comprising:
filling a reactor with water to a predetermined level and adding to the reactor to form a mixture percentages of ochre, phyllosilicate, and clay within ranges of 1% to 50%, 1% to 50%, and 1% to 90% by weight, respectively, based on an analysis of soil characteristics of a target application area to determine specific soil deficiencies and environmental conditions;
agitating the mixture in the reactor until the ochre, phyllosilicate, and clay are mixed to form a clay slurry; and
drying the clay slurry to achieve a moisture content below 20%to form a soil amendment.

11. The method of claim 10 wherein the analysis of soil characteristics includes testing for pH level, nutrient content, and moisture retention capacity.

12. The method of claim 10 wherein the soil amendment is further mixed with a biomass to form a fertilizer.

13. The method of claim 10 wherein agitating the mixture includes using a mechanical agitator for even distribution of ingredients within the slurry.

14. The method of claim 10 wherein drying the clay slurry is via an electronic heat source.

15. The method of claim 10, further comprising testing the soil amendment composition.

16. A method for producing fertilizer comprising:
filling a reactor with water to a predetermined level;
adding to the water 1% to 50% by weight ochre, 1% to 50% by weight phyllosilicate, and 1% to 90% by weight clay to form a mixture;
agitating the mixture to form an aggregated clay slurry;
drying the aggregated clay slurry; and
mixing the aggregated clay slurry with a biomass to form a fertilizer.

17. The method of claim 16 wherein the biomass includes organic waste materials selected from a group comprising agricultural residue, food waste, yard trimmings, and animal manure.

18. The method of claim 16 wherein the mixing step includes adjusting a ratio of aggregated clay slurry to biomass based on nutrient requirements of an intended application area.

19. The method of claim 16 wherein drying the aggregated clay slurry is performed to achieve a final moisture content below 20%to promote microbial activity.

20. The method of claim 16 wherein drying the aggregated clay slurry is via an electronic heat source.
